(19) United States
(12) Patent Application Publication
(10) Pub. No.: US 2020/0380426 A1
(43) Pub. Date: Dec. 3, 2020

(54) SYSTEMS AND METHODS FOR CREATING AND MAINTAINING A SECURE TRAVELER PROFILE FOR CURATING TRAVEL ITINERARIES

(71) Applicant: Travel Labs, Inc., Minneapolis, MN (US)

(72) Inventors: Parker W. SCHLANK, Lakeville, MN (US); Brandon D. BOKINSKIE, Brooklyn Park, MN (US); Zulfikar ALI, Savage, MN (US)

(73) Assignee: Travel Labs, Inc., Minneapolis, MN (US)

(21) Appl. No.: 16/788,972

(22) Filed: Feb. 12, 2020

Related U.S. Application Data
(60) Provisional application No. 62/804,573, filed on Feb. 12, 2019.

(51) Int. Cl. G06Q 10/02; G06F 21/31; G06K 9/00

(52) U.S. Cl. CPC G06Q 10/02; G06K 9/00442; G06F 21/31

(57) ABSTRACT

Systems and methods for onboarding a user of a travel booking system, program, or application. In particular, a secure traveler profile may be created by establishing user identity information, establishing user payment information, creating a travel profile, and linking to a user calendar. In some embodiments, user identity and/or payment information may be verified or confirmed. Creating a travel profile may include receiving information related to a user's travel preferences and/or travel priorities. Additionally, the onboarding process may include establishing a communication link with a user's calendaring application or program, such that new calendar entries may be communicated to the travel booking system, program, or application.

### CROSS-REFERENCE TO RELATED APPLICATIONS

This application claims the benefit of U.S. Provisional Application No. 62/804,573, filed on 12 Feb. 2019, and which application is incorporated herein by reference in its entirety.

### FIELD OF THE INVENTION

The present disclosure relates to novel and advantageous systems and methods for booking travel services. Particularly, the present disclosure relates to novel and advantageous systems and methods for onboarding a user by building a secure traveler profile for a user of a travel booking system.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Whether traveling for business or leisure, searching for and booking travel services is typically a time-consuming and laborious process. To find a desired price and/or desired options, an individual may be required to search on multiple service provider websites, travel websites, and/or other sources. The individual may thus be required to input various search parameters and filters multiple times in order to search the multiple sources. When it comes to business travel in particular, a traveler's company may place restrictions or budget limitations on business travel that may make it even more difficult to find a suitable flight, hotel, ground transportation service, and/or other travel service. While some travelers, particularly some business travelers, can delegate the task of searching for and booking travel services to an assistant, many travelers do not have this option. Many travelers have established particular preferences, patterns of booking travel, or affinities for certain service providers. Additionally, the purchase of airfare often lacks security features to verify that the purchaser of the airfare is the passenger at “point-of-sale” of the airline ticket. Thus, there is a need in the art for improved systems and methods to facilitate booking travel services using a travel profile.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one or more embodiments, relates to a method for developing a traveler profile. In various embodiments, the method may be used to assist with onboarding a user of a travel booking system. The method for developing a traveler profile may include registering the user by associating a username and password for a new user account, and receiving and storing identity information for the user. The identity information may include, for example, the user's name, address, and date of birth. The method may further include verifying the received identity information. In some embodiments, the method may include receiving and storing payment information for the user. The payment information may include, for example, a credit card number and/or bank account number. In some embodiments, received payment information may also be verified. For example, the received payment information may be compared to the identity information for consistency. The method may further include building a travel profile for the user including at least one travel preference. In some embodiments, the method may include establishing a communication link to a digital calendar for the user such that calendar entries made in the digital calendar may be received by the travel booking system.

Receiving identity information may include receiving one or more photos of an identity document, such as a driver's license or passport. The method may include extracting identity information from the photo(s) using text recognition. In some embodiments, verifying the identity information may include comparing text extracted from one photo to text extracted from another photo. If the text does not match, an error may be displayed. In some embodiments, a first photo may include a first side of the user's driver's license, and a second photo may include a second side of the driver's license.

In some embodiments, building a travel profile may include asking the user questions related to the user's travel routine. Building the travel profile may also include receiving and storing travel membership program data related to one or more travel memberships held by the user.

The present disclosure, in one or more embodiments, additionally relates to a system for building a travel profile. The system may include a database storing user identity data, user payment data, and travel profile data, as non-transferable computer readable storage media. The system may further include a controller communicably coupled to the database and having at least a user profile module and a travel itinerary module. The user profile module may be configured for onboarding a user to the system by receiving identity information for the user, including the user's name, address, and date of birth, and verifying the identity information. The user profile module may further be configured to receive payment information for the user, including, for example, a credit card number and/or a bank account number. The user profile module may build a travel profile for the user, the travel profile including at least one travel preference. In some embodiments, the user profile module may further establish a communication link to a digital calendar for the user such that calendar entries made in the digital calendar may be received by the travel booking system. Building a travel profile may include asking the user questions related to the user's travel routine. In some embodiments, building a travel profile may further include receiving and storing travel membership program data related to one or more travel memberships held by the user. In some embodiments, the controller may additionally include a booking module configured to book the booking option of a curated itinerary using the stored identity information and stored payment information. Moreover, the system may include a user interface accessible via a user device and the user profile module may prompt the user to provide the identity information, payment information, and at least one travel preference via the user interface.

The present disclosure, in one or more embodiments, additionally relates to a computer readable storage medium encoded with instructions that, when executed by a computer processor, cause the computer to register a user by associating a username and password for a new user account, receive and store identity information for the user, including a name, address, and date of birth, and verify the identity information. The computer may receive and store payment information for the user, including, for example, a credit card number and/or bank account number. The computer may further build a travel profile for the user, the travel profile including at least one travel preference. The computer may additionally establish a communication link to a digital calendar for the user such that calendar entries made in the digital calendar may be received by the travel booking system. In some embodiments, receiving identity information may include receiving at least one photo of an identity document. The instructions may further cause the computer to extract identity information from the photo(s) using text recognition. In some embodiments, at least two photos may be received, and verifying the identity information may include comparing text extracted from the at least two photos for consistency.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a diagram of a system of the present disclosure, according to one or more embodiments.

FIG. 2 is a flow diagram of a method of the present disclosure, according to one or more embodiments.

FIG. 3 is a data flow diagram for a system of the present disclosure, according to one or more embodiments.

FIG. 4 is a flow diagram of a method of the present disclosure, according to one or more embodiments.

FIG. 5 is a screenshot of a user interface of the present disclosure, according to one or more embodiments.

FIG. 6 is a screenshot of a create new account screen of a user interface of the present disclosure, according to one or more embodiments.

FIG. 7 is a screenshot of a create new account screen of a user interface of the present disclosure, according to one or more embodiments.

FIG. 8 is a screenshot of a create new account screen of a user interface of the present disclosure, according to one or more embodiments.

### DETAILED DESCRIPTION

The present disclosure relates to novel and advantageous systems and methods for developing a secure traveler profile. In some embodiments, the secure traveler profile may be used to onboard a user of a travel booking system, program, or application. In particular, a secure traveler profile may be created by establishing user identity information, establishing user payment information, and creating a travel profile. In some embodiments, the secure traveler profile may include linking to a user calendar. In some embodiments, user identity and/or payment information may be verified or confirmed. For example, systems and methods of the present disclosure may be configured for comparing a user's identity and payment information to determine whether the payment information corresponds with the identity information. In some embodiments, identity and/or payment information may be extracted from one or more photos. For example, a user may be prompted to take a photograph of the user's driver's license, and the user's identity information may be extracted from the photo using text recognition. Creating a travel profile may include receiving information related to a user's travel preferences and/or travel priorities. For example, as part of the onboarding process, a user may be presented with a variety of questions configured to determine the user's travel preferences and/or priorities. Additionally, the onboarding process may include establishing a communication link with a user's calendaring application or program, such that new calendar entries may be communicated to the travel booking system, program, or application.

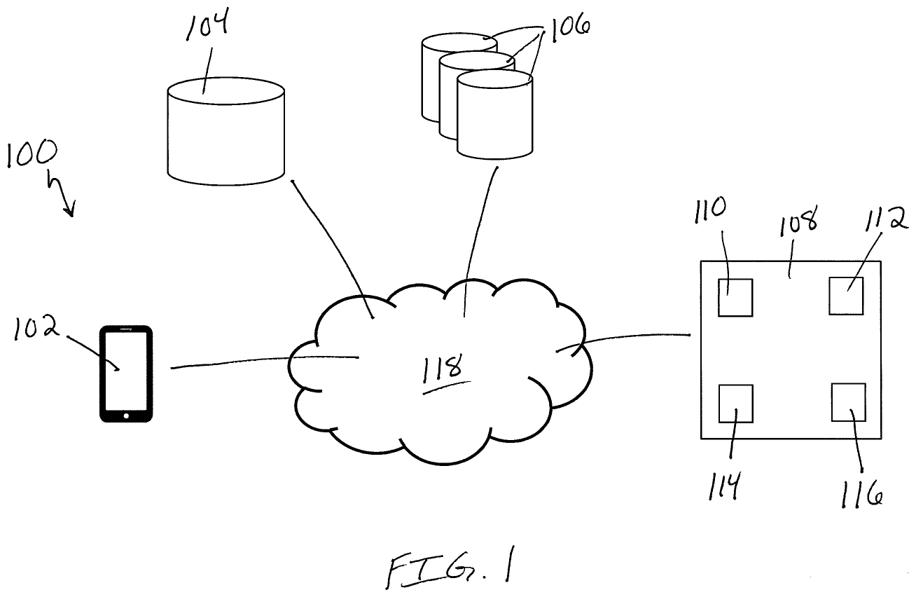

Turning now to FIG. 1, a system 100 for booking travel is shown, according to one or more embodiments. The travel booking system 100 may be configured for suggesting, recommending, and/or booking airfare, hotel accommodations, ground transportation services, and/or other travel services. The travel booking system 100 may suggest, recommend, and/or book such travel services based on a user's planned trips as determined from the user's calendar entries. For example, where a user creates a calendar entry for a meeting, the travel booking system 100 may examine the calendar entry to determine whether the meeting is scheduled to take place at or near the user's current location or in another location. Where the travel booking system 100 determines that the meeting, or other event, is to occur in a distant location, the system may determine travel parameters such as destination and dates of travel. The travel booking system 100 may additionally consider user preferences, such as the user's preferred hotels and airlines, preferred flight times, and others. Based on the travel parameters and user preferences, the travel booking system 100 may access one or more databases for travel providers, such as for airlines, hotels, and rental car or other ground transportation companies, to find suggested or recommended travel services. The travel booking system 100 may recommend or suggest the travel services to the user via a user interface, and in some embodiments, the system may book or facilitate booking one or more travel services.

As shown in FIG. 1, the travel booking system 100 may generally include a user device 102, a database 104, one or more travel provider databases 106, and a controller 108 that may be configured to manage user data, evaluate calendar entries, determine travel parameters, search travel provider databases based travel parameters and user preferences, and suggest, recommend, and/or book travel services. In particular, the controller 108 may include one or more of a user profile module 110, a calendar module 112, a travel itinerary module 114, and a booking module 116. In other embodiments, the controller 108 may include additional and/or alternative modules or other components. Each of the components of the system 100 may be communicably coupled over one or more wired or wireless networks 118.

The user device 102 may be or include a smartphone, smart watch, tablet computer, notebook computer, desktop computer, or other personal computing device. The user device 102 may allow a user to access a user interface for inputting user data such as profile information and travel preferences, viewing travel recommendations, and selecting a travel itinerary. The user interface, described in more detail below, may be or include a program, application, or web-based interface. The user device 102 may further include a calendaring program or application. For example, the user device 102 may include software for providing Google Calendar, Apple Calendar, Microsoft Outlook, and/or other calendaring programs through which a user may create unique calendar entries for upcoming meetings and other events. The calendaring application may allow a user to input a location and time for a calendar entry. The user device 102 may be communicably coupled to each of the database 104, travel provider databases 106, and controller 108.

The database 104 may include one or more local or remote data storage devices for storing, as non-transferable computer readable storage media, data associated with a user's profile, preferences, and/or other user data. The database 104 may be communicably coupled to the user device 102 and controller 108. User profile data may include a user's registration information, such as username and password, and identification information, such as name, date of birth, address, driver's license number, passport number and/or other identification information. User profile data may include payment information, such as credit card information and an associated billing address. Such registration, identification, and payment information may be input by a user, or may otherwise be captured or received, as part of a user onboarding or account creation process, as described in more detail below.

User profile data may additionally include a user's travel preferences, such as preferred travel service providers. Preferences may include, for example, flight preferences, such as preferences for particular flight times, preferences for a minimum or maximum number of stops or length of layovers, preferences for seat selection or seat class, and/or other flight preferences. Preferences may include hotel preferences, such as a preference for room type or size. As a particular example, a user may prefer a room with a view where available, or a user may prefer a kitchenette when a stay will be longer than two nights. Other travel preferences may include preferences regarding length of stay. For example, one user may prefer to fly in the morning of a meeting where possible, while another user may prefer to fly in the evening before a meeting. Preferences may include rental car preferences, such as a preferred size or type of vehicle. Preferences may additionally include cost preferences, such as maximum airfare, hotel cost, rental car cost, or other cost preferences. In some embodiments, preferences may include company or corporate preferences, restrictions, or limitations. For example, a user's company may have a policy for a maximum airfare cost. The user profile data may include a preference reflecting this maximum airfare cost. Other travel preferences are contemplated as well. Travel preferences may be entered by a user, such as during the onboarding process or thereafter. However, in some embodiments, travel preferences may be determined or adjusted based on a user's travel selections. For example, where a user routinely selects recommended travel itineraries with morning flights, the system may recognize and create a user preference for morning flight times and may store the created preference in the database 104.

User profile data may include a user's travel priorities, which may include rankings or importance settings for various travel parameters or preferences. That is, stored priorities may indicate how important particular parameters or preferences are for a user. Priorities may help to evaluate or select suitable travel services for a user. For example, user priorities may include rankings or importance settings for or related to cost, timing, number of flight stops or other flight parameters, airport or hotel distance, hotel amenities or other hotel parameters, or car service or rental parameters.

Each travel provider database 106 may include one or more local or remote data storage devices for storing, as non-transferable computer readable storage media, searchable travel service data. In some embodiments, a travel provider database 106 may be a third-party database. A travel provider database 106 may be associated with a single service provider. For example, a travel provider database 106 may be a Delta database providing searchable flight information for Delta flights. Such databases may be provided and/or maintained by the individual service providers. In some embodiments, a travel provider database 106 may include searchable data for a plurality of service providers. For example, a database 106 may be provided and maintained by Hotels.com, Travelocity, Trivago, Kayak, Expedia, Hotwire, and/or other third-party travel booking sites or companies. In some embodiments, a travel provider database 106 may be a database provided and maintained by Sabre Corporation. Each travel provider database 106 may be communicably coupled with the user device 102 and the controller 108.

The user profile module 110 may include hardware and/or software for receiving, maintaining, and updating user information stored in the database 104. In some embodiments, the user profile module 110 may be configured for performing a user onboarding process or method by prompting a user for identity, payment, and travel preference data. For example, the user profile module 110 may be configured for creating a user account for a new user of the system, and storing a username and password associated with the user account. The user profile module 110 may be configured for receiving and maintaining user contact information and contact or notification settings and user identity data, such as name, date of birth, citizenship, and other identity information. The user profile module 110 may be configured for receiving and maintaining user payment data, such as credit card or bank account information. The user profile module 110 may additionally be configured for receiving and maintaining user preferences and priorities related to travel services. In some embodiments, the user profile module 110 may be configured for helping a user to establish a traveler profile via a user interface at the user device 102. For example, the user profile module 110 may prompt the user to enter identity information, payment information, preferences and priorities, and/or other information. The user profile module 110 may be configured for receiving user data in any suitable form. In some embodiments, the user profile module 110 may be configured to extract text from photographs. For example, the user profile module 110 may be configured to recognize and extract text related to the user's identity from a photo of the user's driver's license.

In some embodiments, the user profile module may further be configured with hardware and/or software for verifying user data. For example, the user profile module 110 may be configured to compare a user's identity data and payment data to determine if the data is likely legitimate. In some embodiments, the user profile module 110 may be configured to compare two pieces of identification, or for example photos of a front and back of a driver's license, to determine if the data is likely valid. In this way, the user profile module 110 may help to protect against a risk of fraudulent travel purchases.

In some embodiments, the calendar module 112 may include hardware and/or software for communicating with a calendaring application or program to receive calendar entry notifications indicating when a user has created a new calendar entry and event data corresponding with the calendar entry. In other embodiments, the calendar module 112 may include hardware and/or software for providing the user with a calendaring interface via the user device 102 through which the user may directly create calendar entries and input event details. The calendar module 112 may further be configured with hardware and/or software to extract travel parameters from calendar event details. For example, the calendar module 112 may analyze event details to determine whether an event includes or requires travel, whether airplane, train, bus, or other travel modes may be suitable, whether a hotel stay may be required or desired, and/or whether a car service or rental car may be desired or required. Additionally, the calendar module 112 may analyze event details to determine suitable arrival and departure times and dates, hotel and airport locations, whether a hotel stay may be needed, whether a rental car or car service may be needed, and/or other travel parameters.

The travel itinerary module 114 may include hardware and/or software for applying travel parameters, user preferences, and/or user priorities to curate one or more suitable travel itinerary suggestions. In particular, the travel itinerary module 114 may be configured to searching the one or more travel provider databases 106 using travel parameters. Travel parameters may be extracted from event data by the calendar module 112, as described above. Travel parameters may additionally be created or modified by the travel itinerary module 114 based on user preferences. For example, the travel itinerary module 114 may create a travel parameter based on a user preference for particular hotel amenities (i.e., room service, city view, continental breakfast, etc.). The travel itinerary module 114 may additionally or alternatively modify travel parameters based on user preferences. For example, where a stored user preference indicates that the user prefers morning flights, parameters related to arrival time and departure time may be modified to designate morning flight times. The travel itinerary module 114 may further be configured to apply stored user priorities. For example, the travel itinerary module 114 may apply user priorities to travel parameters as weighted coefficients to designate importance of some parameters. In other embodiments, the travel itinerary module 114 may apply or accommodate user priorities in other ways. The travel itinerary module 114 may further be configured to search the one or more travel provider databases 106 using the travel parameters, as determined from event details and user preferences and as adjusted or weighed by the user priorities.

The travel itinerary module 114 may further be configured to curate one or more travel itinerary suggestions to include suitable travel services. In particular, the travel itinerary module 114 may be configured to select travel services from the one or more travel provide databases 106 that correspond with or generally satisfy the applicable travel parameters, user preferences, and/or user priorities. The travel itinerary module 114 may combine different travel services (such as flight, hotel, and car rental) to create a tailored travel itinerary to meet the user's travel needs. Additionally, the travel itinerary module 114 may be configured for presenting the one or more curated travel itineraries to a user via the user device 102 such that a user may select on confirm an itinerary.

The booking module 116 may include hardware and/or software to facilitate booking one or more travel services. In some embodiments, where a user selects a suggested travel itinerary, the booking module 116 may be configured to automatically schedule and/or purchase the one or more travel services included in the itinerary. In particular, the booking module 116 may use stored identity data and payment data for the user to book and purchase the selected travel services from the service providers. The booking module 116 may ask the user, via the user device 102, to confirm or finalize the booking. In other embodiments, the booking module 116 may facilitate booking travel services by prompting the user to enter identity information and/or payment information. In still other embodiments, the booking module 116 may facilitating booking travel services by connecting or linking the user to one or more service provider platforms where the user may book the services.

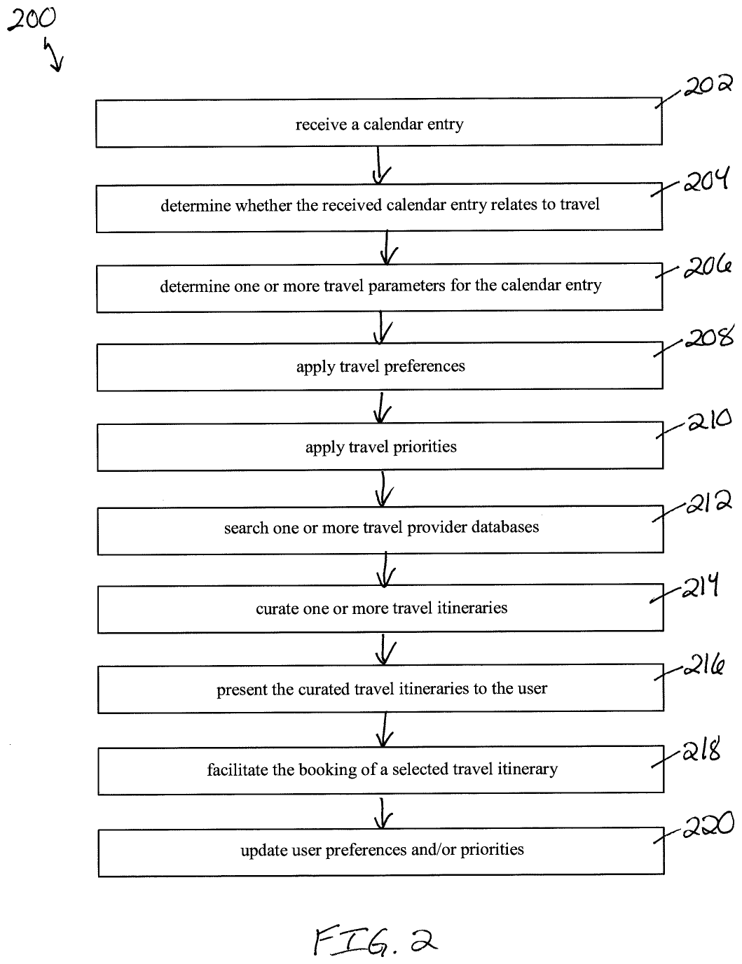

Turning now to FIG. 2, a method 200 for booking travel, which may be performable or executable via a system of the present disclosure, is shown according to one or more embodiments. The method 200 may include the steps of receiving a calendar entry 202; determining whether the received calendar entry relates to travel 204; determining one or more travel parameters for the calendar entry 206; applying the user's travel preferences 208; applying the user's travel priorities 210; searching one or more travel provider databases 212; curating one or more travel itineraries 214; presenting the curated travel itineraries to the user 216; facilitating the booking of a selected travel itinerary 218; and updating the user's preferences and/or priorities 220. In other embodiments, the method 200 may include additional or alternative steps.

Receiving a calendar entry 202 may include receiving event data, such as an event time, location, and duration directly from a user via a user interface. In other embodiments, the calendar entry may be received from another application, program, or system. In some embodiments, receiving a calendar entry may include pinging or querying another application, program, or system to determine whether a new calendar entry was made by the user. Still other embodiments may use other means for receiving a calendar entry.

Determining whether the received calendar entry relates to travel 204 may include receiving an express indication from a user that the calendar entry relates to, or requires, travel. For example, in some embodiments, the method may include, upon determining a user is making or has made a new calendar entry, asking the user via the user interface whether the new calendar entry relates to or requires travel. In other embodiments, a system of the present disclosure may evaluate event data associated with the calendar entry to determine whether the user will likely desire travel services to attend the event. In one embodiment, an event location associated with the calendar entry may be compared with the user's location, which may be previously identified or may be determined based on geolocation of the user's device. If the comparison shows that the event location for the calendar entry includes a different city or state than the user's location, for example, it may be determined that the user may desire travel services. In other embodiments, if the event location is outside of a predefined radius or distance from the user's location, such as more than 200 miles, 300 miles, or 400 miles for example, it may be determined that the user may desire travel services. In some embodiments, after automatically determining that the user may benefit from travel services to attend the event, the method may include asking the user to confirm whether the event is a trip or whether the user would like travel service recommendations.

Determining travel parameters for the calendar entry 206 may include extracting trip details from the calendar entry that may be used to search for suitable travel services. In particular, the received event location, time and date, duration, and/or other event data may be analyzed to determine travel parameters for arrival time and date, departure time and date, closest airports, number of overnights, whether a rental car or car service may be needed, and/or other travel parameters. For example, an event location may be parsed to determine a destination city for the user's event. In some embodiments, the event location may be compared to known airport locations to determine one or more suitable airports into which the user may wish to fly to reach the event. The start time, end time, and/or duration of the event may be analyzed to determine suitable arrival and/or departure dates and times for the event. For example, where the calendar entry includes an out-of-town meeting beginning at 8 AM, suitable arrival times may include any flights arriving by at least 7 AM or flights arriving the prior evening. When determining suitable arrival and departure times, a time buffer of, for example, at least one hour or at least two hours may be included around calendar entry start and end times. Event times and/or duration may additionally be analyzed to determine whether a hotel stay may be needed and further to determine how many nights may be needed at a hotel. For example, where the event includes a two-day conference, it may be determined that a one-night or two-night hotel stay may be needed depending on available flights. In some embodiments, determining travel parameters may include determining whether a trip includes multiple stops or destinations, as described for example in U.S. application Ser. No. 16/273,946, entitled Systems and Methods for Multi-Destination Travel Planning Using Calendar Entries, and filed on Feb. 12, 2019, the content of which is hereby incorporated by reference herein in its entirety.

Applying the user's travel preferences 208 may include adjusting or adding travel parameters based on predefined or predetermined user preferences related to flights, hotels, car rental or car services, and/or other user travel preferences. Travel preferences related to flights may include preferred airlines, flight times, preferences related to layovers or stops, preferences related to seat availability or selection, or seat class. Other flight preferences may include preferences related to when or how a user prefers to travel. As a particular example, a user's flight preference may include that, when the user has a morning out-of-town meeting, the user prefers to arrive the night before the meeting. As another particular example, a flight preference may include that a user prefers to arrive at an airport at least three hours prior to a flight. Travel preferences related to hotels may include preferred hotel brands or locations, room type or size, hotel star rating, amenities, check-in or check-out times, or other hotel preferences. Car rental or car service preferences may include circumstances under which a user prefers to rent a car or prefers to rely on public transportation, taxis, ride shares, or black car services. As particular example, a user may prefer to rent a car when the user plans to be in town for more than one night or where the user has more than one meeting or event at the destination. Car rental preferences may additionally include preferred car rental companies, vehicle sizes or types, vehicle options, or other preferences. Other user preferences may relate to costs. For example, a user may set a maximum cost or a cost range for airfare, hotel, and/or car services or car rental.

Applying the user's travel priorities 210 may include adjusting the travel parameters based on predefined or predetermined user priorities related to flights, hotels, and/or car rental or car services. The user's travel priorities may indicate or rank the importance of particular parameters or factors. For example, a user may indicate that price is a most important travel parameter or that the user is particularly price conscious. As another example, a user may indicate that the availability of non-stop flights is a most important or particularly important travel parameter. As another example, a user may indicate that hotel distance is not a high priority for the user. In some embodiments, the user's priorities may be applied to travel parameters as weighted coefficients to help search for and/or select appropriate travel services to match the user's preferences.

Searching travel provider databases 212 may include accessing one or more travel provider databases containing flight, hotel, car rental, and/or other suitable travel services. Such databases may be searched using travel parameters extracted from event data, user preferences, and applicable priorities. For example, parameters such as time and date of arrival and departure may be selected based on event data for the calendar entry, but may be modified based on user preferences. Parameters related to a maximum number of flight stops or length of layovers, seat class, seat selection, and/or other flight parameters may input to the search based on user preferences. Airport and hotel location parameters may be based on event data, but modified based on applicable user preferences. Parameters reflecting desired hotel amenities, star rating, brand, and/or other hotel parameters may be added based on user preferences. Additionally, based on the event data, it may be determined whether a rental car is needed. The user's stored preferences related to type or brand of rental car, or other rental car preferences, may be used to modify or add rental car parameters. User preferences related to cost of various travel services or total itinerary cost may be used to input cost parameters for the search. Additionally, user priorities may be used to weigh the travel parameters appropriately. For example, where a user indicates high importance for total cost, one or more cost parameters may be assigned a relatively high coefficient value. Similarly, where a user indicates that total cost is unimportant, one or more cost parameters may be assigned a relatively low coefficient value.

Based on search results, one or more itineraries may be curated 214 to include flight, hotel, car rental or car service, and/or other suitable travel services. A suitable travel itinerary may include, for example, flight, hotel, and rental car information that best meets a user's preferences and priorities. Where there are multiple travel service options that may satisfy the travel parameters, as well as the user's preferences and priorities (such as, for example, alternate flights or alternate hotel reservations), alternate itineraries may be curated to present to the user as options. It is to be appreciated that in some embodiments, itineraries or alternate itineraries may be built based on travel services that most closely align with the parameters, user preferences, and user priorities, even where such parameters, preferences, and priorities may not be entirely satisfied in each case.

The one or more curated travel itineraries may be presented to the user 216 via the user interface. Each itinerary may include a grouping of travel services suitable for a particular calendar entry or for a particular trip. For example, a travel itinerary may include departing and returning flight information, hotel information, and/or car service or car rental information. Where a trip does not include an overnight stay, the itinerary may be presented without the need for hotel information. Where alternate itineraries are presented, some itineraries may include different services than others. For example, a first alternate itinerary may include a next-day flight, and may require an overnight stay such that the itinerary includes hotel information, while a second alternate itinerary may include a day-of flight, and thus may not require the overnight stay and may not include hotel information. In some embodiments, a maximum of two or three alternate itineraries may be presented to the user. The user may additionally have an option to request different or additional itinerary options if, for example, the user is not satisfied with the options presented. The itinerary options may be presented with a total price for all of the travel services included in the itinerary and/or may present a price breakdown of the individual travel services. Itineraries may be presented as selectable icons, links, or options from which the user may indicate the user's choice.

In some embodiments, the method 200 may include booking travel based on the user's selected itinerary 218. In some embodiments, where the user's payment information and identity information is stored, the travel services associated with the user's selected itinerary may be purchased and scheduled automatically. In some embodiments, the user may be requested to confirm the booking and/or finalize some details for the booking. In other embodiments, where a user selects an itinerary, the user may be taken to a booking page where the user may input identity and payment information to book and purchase the one or more travel services for the itinerary.

In some embodiments, the user's stored preferences and/or priorities may be updated based on the user's selected itinerary 220. For example, where a user selects an itinerary having a higher total price than other itineraries but having non-stop flights, the user's stored preferences may be updated to reflect that the user may prefer non-stop flights and the user's stored priorities may be updated to reflect that the user may prioritize non-stop flights over cost. In some embodiments, the user may be asked to confirm whether the user's stored preferences and/or priorities should be amended or updated based on the selected itinerary.

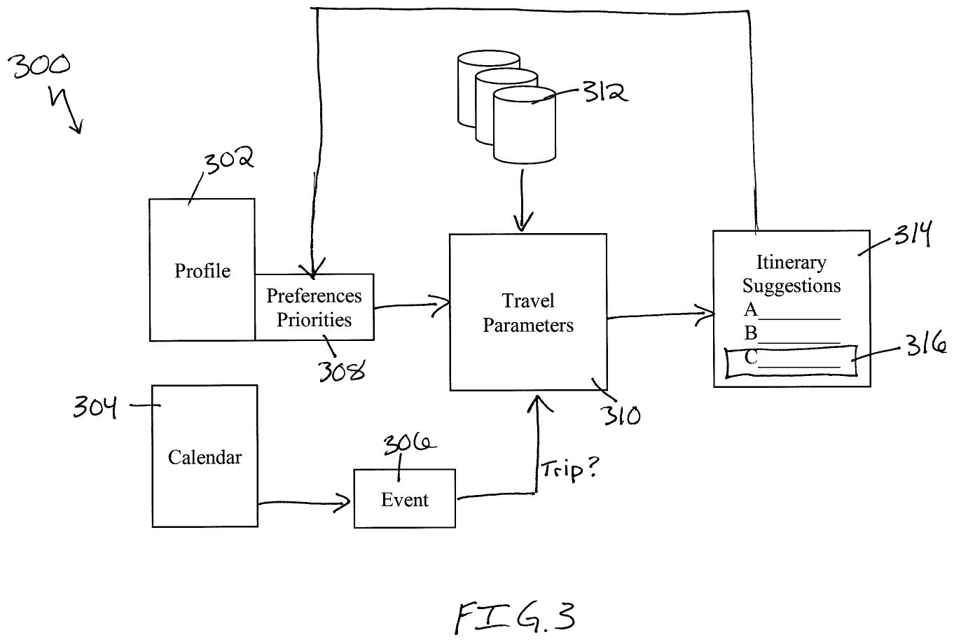

Turning now to FIG. 3, a system data flow 300 of the present disclosure is shown, according to one or more embodiments. As shown, a user may generally have a profile 302 and a calendar 304. The profile 302 may include user preferences and priorities 308, as described above. The profile 302 may additionally include user identity and payment information in some embodiments. The calendar 304 may include event data for calendar entries created by the user, by other individuals, and/or by other applications or programs. Event data may include start time and date, end time and date, duration, location, attendees, and/or other details. The profile 302 and calendar 304 may be maintained and/or provided via separate programs or applications, or may be provided and maintained by a single program or application.

As further shown in FIG. 3, when a user (or other source) creates an event 306 via the calendar 304, it may first be determined whether the event includes a trip or whether the user may benefit from one or more travel services to attend the event. The event 306 and user preferences and priorities 308 may be combined to develop travel parameters 310. The travel parameters 310 may be used to search one or more travel provider databases 312 for suitable travel services. Suitable travel services that meet or generally satisfy the travel parameters 310 may be combined into one or more travel itinerary suggestions 314, each of which may include one or more travel services. The itinerary suggestions 314 may be presented to a user such that a user may select a preferred itinerary 316 from the selections. Moreover, based on a user selection of a preferred itinerary 316, the user's preferences and priorities 308 may be updated to reflect any changes as a result of the user's selection.

In the present disclosure, improved systems and methods for booking, or facilitating the booking of, travel services have been described. The systems and methods described herein may help a user to more efficiently and easily schedule and purchase travel services for business or leisure travel. Such travel services may include airfare, train travel, bus travel, ship travel, hotel or motel accommodations, other hospitality services or accommodations such as short-term home or apartment rentals (e.g., AirBnB or homeaway.com), taxi services, ride share services (e.g., Uber or Lyft), rental car services, or other ground transportation services. Still other travel services are contemplated as well. Systems and methods of the present disclosure may greatly reduce an amount of time and effort that a user may otherwise need to search for and book travel services through conventional means. Additionally, systems and methods of the present disclosure may provide a user with curated and individualized travel itineraries tailored to the user's particular preferences and priorities and scheduled to ensure the user reaches calendared meetings and events. Moreover, where the user has particular corporate or company travel restrictions, systems and methods of the present disclosure may be configured to accommodate such restrictions to ensure that the curated itineraries will be acceptable to the user's company.

Systems and methods of the present disclosure may provide for improvements in the field of travel planning, and particularly in the field of smart or automatic travel planning. In contrast to conventional travel planning systems and methods, systems and methods of the present disclosure may provide for a more efficient and tailored travel planning or booking process. By curating travel itineraries based on a user's calendar entries, a user's process for selecting and scheduling travel services may be greatly improved. Systems and methods of the present disclosure, or portions thereof, may be configured to operate automatically. For example, in some embodiments, a suggested travel itinerary may be presented to the user automatically after the user creates a calendar entry. Moreover, in some embodiments, a user need only confirm a suggested itinerary, and the travel services may be purchased and booked automatically.

It is to be appreciated that systems of the present disclosure may be configured to learn or adjust for user preferences and priorities. That is, when a user makes a selection for a particular itinerary or for a particular travel service or group of travel services, systems of the present disclosure may record the user's selection and/or compare the user's selection to itineraries or services that the user did not select. As a particular example, where a user is presented with multiple itinerary suggestions, and the user selects (or routinely selects) itineraries or travel services having a relatively low cost as compared with other suggestions, the system may store a use preference or priority for low cost services. The system may then factor the preference or priority for low cost services into future suggestions. In this way, a system of the present disclosure may suggest more tailored recommendations over time based on the user's preferences and priorities as learned from previous user selections.

In some embodiments, systems and methods of the present disclosure may be configured to integrate with a voice command system or device. For example, systems and methods of the present disclosure may be configured for communication with an Amazon Echo device, a Google Home device, Apple HomePod device, or other smart home device or voice-activated device or system. For example, a user may create a calendar entry using such a device, and the device may communicate the calendar entry to a system of the present disclosure. In other embodiments, a user may instruct a smart home or other voice-activated device or system to search for, or book travel for, a particular event or date. Such instructions may be communicated from the smart home device to, for example, a controller of the present disclosure.

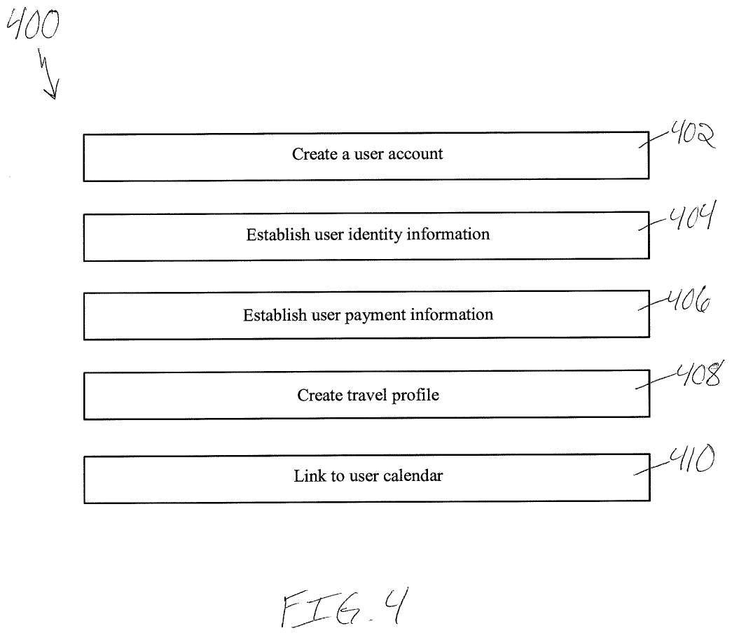

Turning now to FIG. 4, a method 400 of creating a user travel profile of the present disclosure is shown, according one or more embodiments. The method may include the steps of creating a user account 402, establishing user identity information 404, establishing user payment information 406, and creating a travel profile 408. In some embodiments, the method may also include the step of linking to a user calendar 410. In other embodiments, the method 400 may include additional or alternative steps.

Creating a user account 402 may include receiving registration information from a user. For example, a user may be prompted to enter a username and password. Moreover, in some embodiments, creating a user account may include establishing a two-factor authentication link. In some embodiments, the user may be prompted to enter contact information, such as an email address, phone number, and/or other contact information to establish two-factor authentication for logging into the system and/or for booking travel services. Such two-factor authentication may help to protect against fraudulent activity. In at least one embodiment, the user is never prompted to enter the user's first name and/or last name to create a user account. In at least one embodiment, the user is never prompted to enter the user's home address or billing address to create a user account. The user's username, password, email address, and/or phone number other personal information may be stored in a database, such as database 104 described above. In some embodiments, creating a user account may include establishing the user's desired notification settings. For example, the user may be prompted to select a mode of communication (such as SMS text message, email, or push notifications) for notifications related to travel itinerary suggestions and/or other notifications. The user may be prompted to set other settings as well.

Establishing identity information 404 may include receiving identity information from a user. Identity information may include name, address, age, social security number, citizenship country and status, military status, driver's license number, passport number, age, date of birth, and/or other identity information. In some embodiments, the user may be prompted to enter this information. In some embodiments, at least some identity information is obtained only via one or more scanned images. For example, a user may be prompted to scan, take, or create an image of the user's driver's license, passport, or other established travel credential. In at least one embodiment, the user may be prompted to take a photo or digital image of each of the front and back of the user's driver's license, passport, or other established travel credential using a camera function of a device of the user. Text recognition software may be used to obtain identity information from the image(s) and, in some embodiments, may be used to separately display identity information. For example, the text recognition software may obtain the user's name and home address from the image(s). Additionally, in some embodiments, one or more images of a user's document(s) may be used to verify the user's identity information. For example, where is prompted to submit images or photos of the front and back of the user's driver's license, identity information extracted from the images or photos may be compared to government databases or other established databases to ensure they match and are thus likely from a same and legitimate driver's license. Similarly, in some embodiments, a user may be asked to send or upload images or digital photographs of at least two different identifying documents (such as a driver's license and a passport). Identity information extracted from the two photos may be compared to ensure matching information. It is to be appreciated that extracting information directly from identifying, such as a driver's license or passport, may help to mitigate a risk of fraudulent activity. By requiring that a user produce a copy of the user's identifying document, this may help to reduce a risk of creating an account using stolen identity information. In still other embodiments, information extracted from a photo or otherwise obtained from the user may be compared to a database of identifying information, such as a Department of Motor Vehicles database or other government database to ensure a match. Once identifying information is extracted from photographs or otherwise obtained, a user may be prompted to confirm that the information was correctly entered or extracted. The user's identity information may be stored in a database, such as database 104 described above.

Establishing payment information 406 may include receiving payment information from a user and storing such information in a database, such as database 104 discussed above. Payment information may include, for example, a credit card number, credit card holder name, expiration date, billing address, CVV number, and/or other credit card information. Payment information may include bank account information, such as an account number and routing number for a checking or savings account. In other embodiments, other payment information may be received from the user or from another source. Establishing payment information may further include receiving permissions or authorizations from the user to use the payment information to complete purchases. In some embodiments, a user may be prompted to confirm that payment information was entered or extracted correctly. Receiving identity and payment information may be performed as part of account creation in some embodiments.

In some embodiments, received payment information may be verified by, for example, comparing the received payment information to received or stored identity information for the user. For example, a cardholder name for a credit card may be compared with a name on the user's driver's license or other identity document. If the payment information name and the identity information name do not match, an error message may be issued and/or the user may be prevented from using the payment information or from completing the travel profile. This may provide for additional protections against a risk of fraud. In particular, this may help to protect against use of stolen credit card information, stolen bank account information, or other stolen payment information.

It is to be appreciated that where information, such as front and back driver's license information or payment and identity information, is compared, such comparisons may be configured to allow for syntax errors. For example, where a middle name is represented on a driver's license with only a first letter, but is spelled out on a credit card, the names may still be considered matching where the first and last names on the driver's license and credit card are identical. Similarly, where a last name is hyphenated on a passport, but lacks a hyphen on a credit card, the names may be considered matching where the spellings of the names are identical.

Creating a travel profile 408 may include receiving information from a user related to the user's travel statuses and loyalty programs. For example, the user may be prompted to enter information related to security clearances or statuses, such as TSA Pre-Check enrollment, DHS Trusted Traveler or Global Entry enrollment, and/or other security or clearance programs or levels. Information about the user's security or clearance programs or levels may provide for more tailored travel itineraries in some embodiments. Creating a travel profile may additionally include receiving from the user information related to the user's travel preferences. For example, the user may be prompted to enter travel preferences and/or priorities related to flights and airfare, hotel accommodations, ground transportation, and/or other travel services. In some embodiments, the user may be asked to respond to questions configured to reveal the user's preferences and/or priorities. Such questions may relate to the user's travel routines or previous trips. As a particular example, the user may be asked whether the user prefers to arrive at an airport early before a flight.

In some embodiments, creating a travel profile 408 may additionally include determining a user location. The user location may be determined by prompting a user to select or enter a city or zip code, for example. In other embodiments, the user location may be determined based on the user's identity information, and the user may be prompted to confirm the location. In still other embodiments, the user location may be determined by GPS data and/or by geolocation. In particular, GPS data may be used to determine a location or approximate location of the user's user device. In some embodiments, the user may be prompted for permission to access GPS data associated with the user device. The user may be prompted to confirm that the geolocation is accurate. In some embodiments, creating a travel profile may further include determining a home airport, which may be an airport from which the user most often travels or may be a commercial airport nearest the user's home or nearest the user location. The home airport may be determined automatically based on the user location in some embodiments. In other embodiments, the user may be prompted to enter or select a home airport. It is to be appreciated that, in some embodiments, a home port for other modes of travel, such as a bus or train stop or station, may be established as well.

Linking to a calendar 410 may include establishing a data link between a travel planning program, application, or system of the present disclosure and a user's calendaring application, program, or system. Calendaring applications, programs, or systems may include Microsoft Outlook, Microsoft Office, Google Calendar, Apple Calendar, and/or other suitable calendaring programs. To establish a communication link, a user may be prompted to input a username, password, and/or other information for the calendaring program. The user may be prompted to authorize the link. The communication link may allow the travel planning program and calendaring program to share data. For example, the communication link may allow a travel planning program, application, or system to access calendar entries entered into the calendaring program.

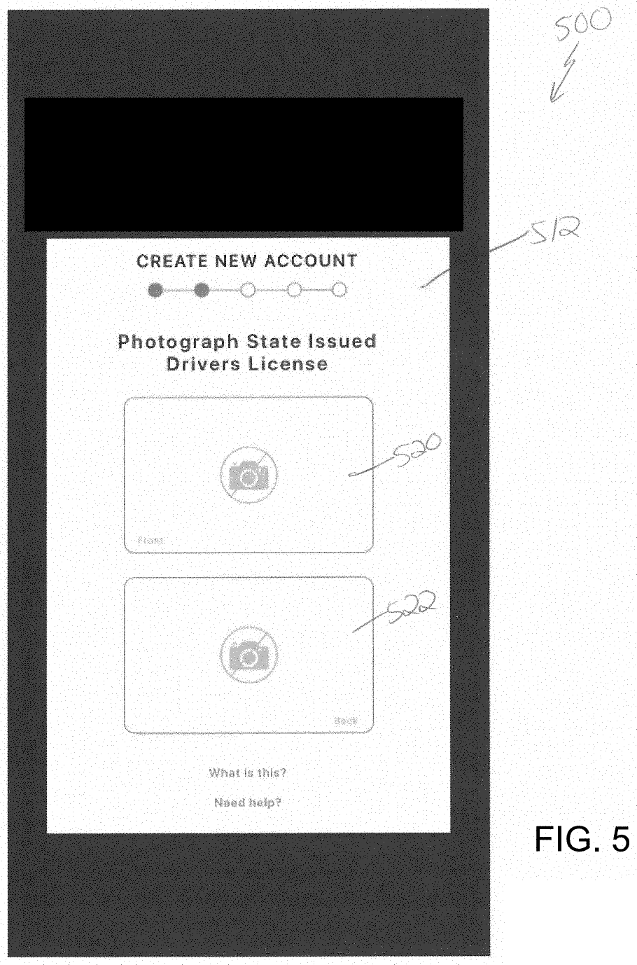

FIGS. 5-9 demonstrate a user interface 500 of the present disclosure, according to one or more embodiments. The user interface 500 may allow a user to access and interface with systems of the present disclosure. The user interface 500 may be provided as a locally stored, remotely stored, or cloud-based application or program. In other embodiments, the user interface 500 may be accessible as or through an Internet website. The user interface 500 may be accessible through a smartphone, notebook computer, desktop computer, tablet computer, smart watch, or other user device. FIGS. 5-21 demonstrate the user interface 500 with respect to creation of a traveler profile for a user.

A welcome screen 502 that may be displayed upon initially opening or launching the user interface 500. The welcome screen 502 may include options for creating an account 504, creating a travel profile 506, authorizing a calendar link 508, and getting started in planning travel services 510 or otherwise using the program or application. In some embodiments, a user may be directed through each option sequentially.

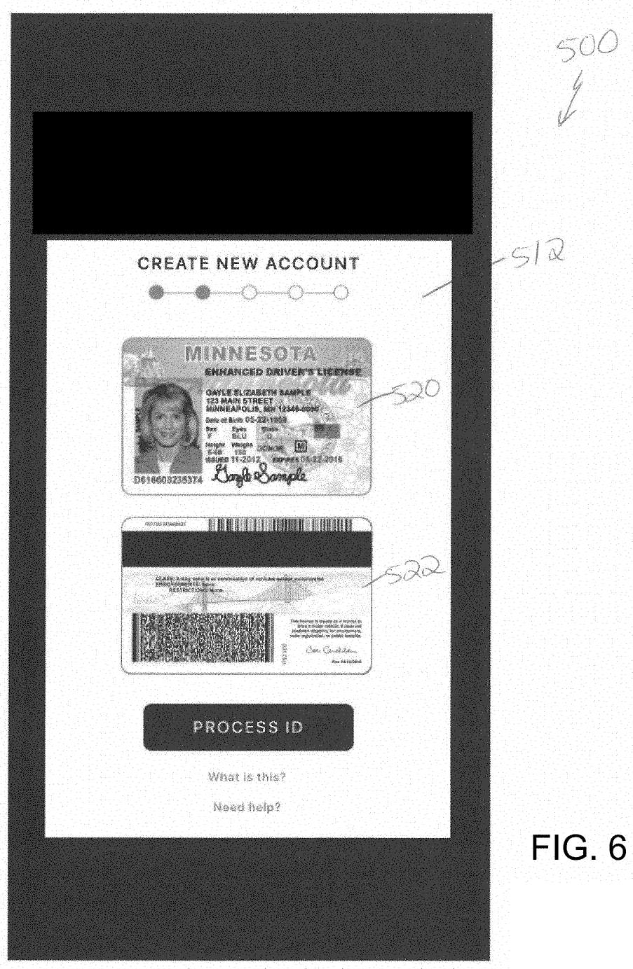

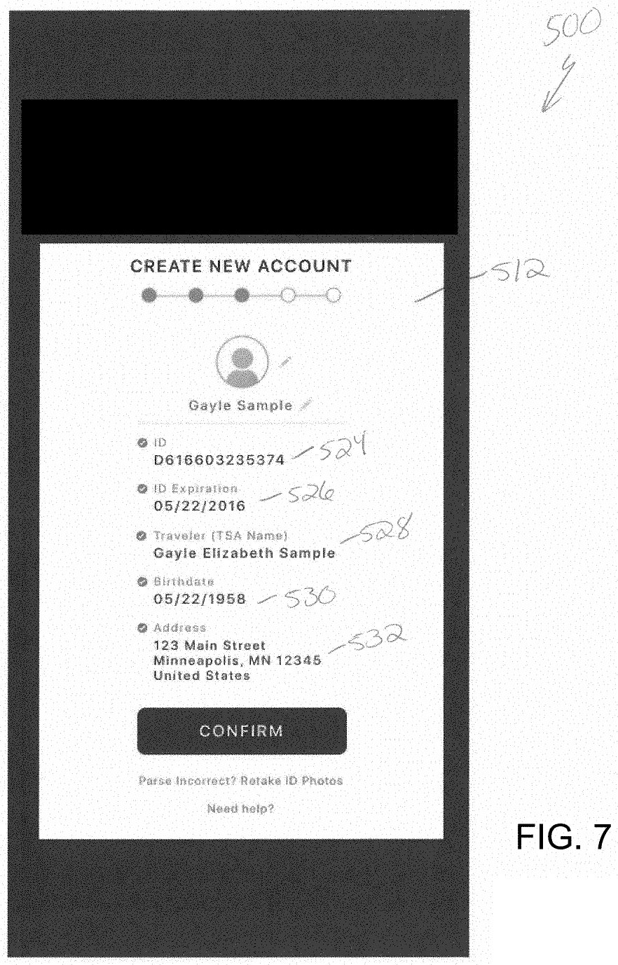

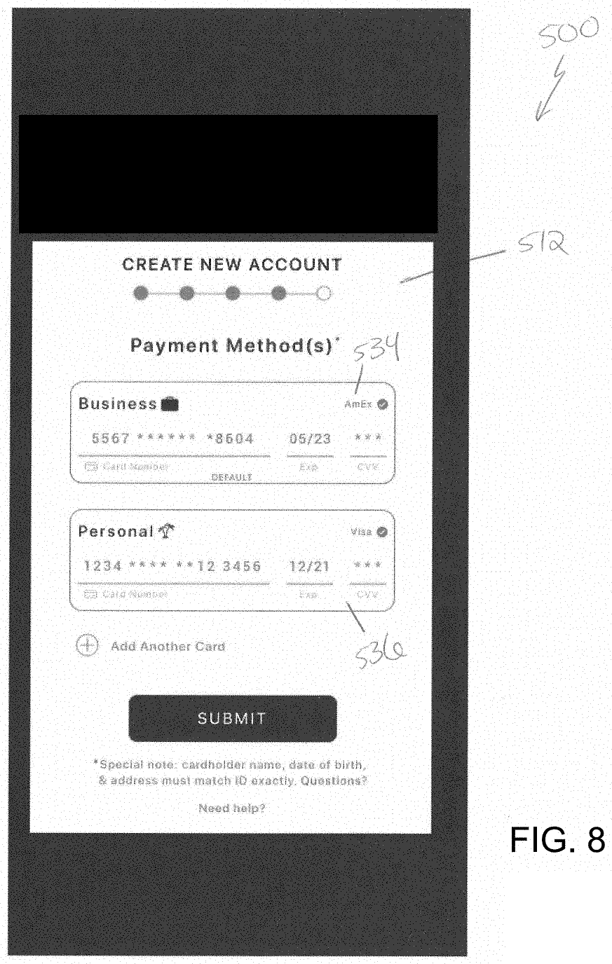

FIGS. 5-8 demonstrate interface option screens that a user may see for creating a new user account 512. The screen 512 may include fields for the user to enter an email address, mobile phone number, and password. As indicated above, creating an account may include receiving an indication of how the user would like to receive notifications, such as notifications of a travel itinerary recommendation and/or other notifications. A user may select whether the user wishes to receive notifications through the interface 514, via email message 516, or through SMS text message 518. The create new account screen 512 may further include establishing two-factor authentication, for a which a user may confirm a code received via text message, email, or another method. As part of the create an account screen 512, the user may be prompted to enter identifying information. As described above, identity information may be extracted from one or more photos of a driver's license or other identifying document. FIG. 6 shows one embodiment where a user may be prompted to enter photos of a front 520 and back 522 of the user's driver's license. The user may capture the photos using a camera function of the user device. Once the user submits the front and back photos, text may be extracted from the photos. Further, in some embodiments, text extracted from the front and back of the driver's license (or from other photos of other documents) may be compared for consistency. FIG. 7 illustrates an example of information extracted from a user's driver's license photos. Such information may include a driver's license number 524, driver's license expiration date 526, name 528, date of birth 530, and street address 532. Creating an account may further include collecting payment information. FIG. 8 shows another account creation screen 512 in which a user may be prompted to enter payment information, such as credit card or bank account information including an account number, expiration date, and security code. In some embodiments, a user never enters the name on the credit card or address with the payment information. In some embodiments, the user may be prompted to scan an image of the credit card or bank account information, and only the account number, expiration date, and/or security code from the card are extracted and read. Payment information may allow for purchasing travel services. In some embodiments, the user may enter more than one payment method, such as a credit card for business travel 534 and a credit card for personal travel 536. In some embodiments, using a third party database associated with the user's payment method(s), the limited payment information provided by the user is compared to the information extracted from the user's driver's license photos. For instance, the address stored at the third party database for the account number may be compared to the street address 532 extracted from the user's driver's license photos. As another example, the name stored at the third party database for the account number may be compared to the name 532 extracted from the user's driver's license photos. It is to be appreciated that comparing account information with information extracted from an image or digital photograph of the user's credential, without the user ever entering his or her name or address, may help to mitigate a risk of fraudulent activity. By comparing the account information for the payment method with information extracted from an image or digital photograph of the user's credential, this may help to reduce a risk of flights or travel purchases made using stolen identity information.

A user may create a travel profile As part of a travel profile, the user may be prompted to enter information related to security clearances, loyalty programs, or memberships. A user may be prompted to enter security service information 540, airline loyalty program information, hotel loyalty information 5dd, and/or other security, loyalty, or reward programs or memberships. Creating a travel profile may further include establishing a user location. For example, a user may be prompted to allow for geolocation of the user's device. A user may additionally be prompted to set a home airport. In some embodiments, a home airport may be suggested based on the determined user location.

Creating a travel profile may further include prompting a user with questions configured to determine user preferences and priorities. For example, the user may be asked questions about the user's general travel routine. Example questions may relate to whether the user prefers same-day business travel or overnight stays, how the user prefers to travel to the airport, or how the user prefers to spend time leading up to a flight. The user may additionally be asked questions about the user's flight preferences. Questions may relate to a user's preferred maximum number of layovers or preferred airlines, for example. Other questions for building a travel profile may relate to the user's preferences with respect to other travel services, such as hotel preferences. Questions configured for determining a user's preferences and priorities may be multiple-choice questions, yes/no questions, true/false questions, free form questions, and/or other question types.

A calendar authorization screen may prompt a user to authorize a communication link to the user's calendar application or program. A user may select from known calendar applications and programs, and may be prompted to enter the user's email address, username, and/or password for the particular calendar application or program the user wishes to link.

An interface menu may be provided for a user to navigate from the user interface 500. In some embodiments, through the user interface 500, the user may have options to search for and/or book a new trip, view pending or scheduled trips, and view historical trips the user has taken. Other options may be provided as well. In some embodiments, the user's pending trips, scheduled trips, and/or historical trips may be populated from the loyalty programs and membership databases. In some embodiments, the user's pending trips, scheduled trips, and/or historical trips may be populated from information received from databases linked to the user's payment information such as the user's credit card. A user may also have the option to view and/or edit profile data, including identity data, payment data, and/or preference and priority data.

It is to be appreciated that, in some embodiments, a user's traveler profile, including stored identity information, stored payment information, and stored travel preference and priority information may be portable such that the user may maintain the traveler profile when changing jobs or moving to a new company, for example. Additionally, in some embodiments, a user's the user's traveler profile, or portions thereof, may be stored locally on the user's device. In particular, identity and payment information may be stored locally on the user's device. In some embodiments, such information may be stored in a secure remote location, such as secure cloud storage location.

Once the user's traveler profile has been initially established, the user's preferences and priorities for flights, hotel, and other travel may be updated in an iterative manner based on one or more of the pending trips, scheduled trips, and/or historical trips taken by the user. In some embodiments, once the user's traveler profile has been initially established, the user's preferences for flights, hotel, and other travel may be updated based on additional loyalty programs or memberships added to the user's traveler profile.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A method for onboarding a user of a travel booking system, the method comprising:
registering the user by associating a username and password for a new user account;
receiving and storing identity information for the user, the identity information comprising the user's name, address, and date of birth;
verifying the received identity information;
receiving and storing payment information for the user, the payment information comprising at least one of a credit card number and a bank account number; and
building a travel profile for the user, the travel profile comprising at least one travel preference.

2. The method of claim 1, wherein receiving identity information comprises receiving at least one photo of an identity document.

3. The method of claim 2, wherein the identity document is a driver's license or a passport.

4. The method of claim 3, further comprising extracting identity information from the at least one photo using text recognition.

5. The method of claim 4, wherein receiving identity information comprises receiving at least two photos of one or more identity documents, and wherein verifying the received identity information comprises comparing text extracted from the at least two photos for consistency.

6. The method of claim 5, further comprising displaying an error if text extracted from a first photo does not match text extracted from a second photo.

7. The method of claim 6, wherein the first photo is a photo of a first side of the driver's license and the second photo is a photo of a second side of the driver's license.

8. The method of claim 1, further comprising verifying the received payment information.

9. The method of claim 8, wherein verifying the received payment information comprises comparing the received payment information to the received identity information for consistency.

10. The method of claim 1, wherein building a travel profile comprises asking the user questions related to the user's travel routine.

11. The method of claim 1, wherein building a travel profile further comprises receiving and storing travel membership program data related to one or more travel memberships held by the user.

12. A system for providing a curated travel itinerary, the system comprising:
a database storing user identity data, user payment data, and travel profile data as non-transferable computer readable storage media;
a controller communicably coupled to the database and comprising:
a user profile module configured for onboarding a user to the system by:
receiving identity information for the user, the identity information comprising the user's name, address, and date of birth;
verifying the received identity information;
receiving payment information for the user, the payment information comprising at least one of a credit card number and a bank account number;
building a travel profile for the user, the travel profile comprising at least one travel preference; and
establishing a communication link to a digital calendar for the user such that calendar entries made in the digital calendar may be received by the travel booking system; and
a travel itinerary module configured for developing a curated travel itinerary comprising at least one booking option based on the user's travel profile.

13. The system of claim 12, wherein building a travel profile comprises asking a user questions related to the user's travel routine.

14. The system of claim 12, wherein building a travel profile further comprises receiving and storing travel membership program data related to one or more travel memberships held by the user.

15. The system of claim 12, wherein the controller further comprises a booking module configured to book the at least one booking option of the curated travel itinerary using the stored identity information and stored payment information.

16. The system of claim 12, further comprising a user interface accessible via a user device and wherein the user profile module prompts the user to provide the identity information, payment information, and at least one travel preference via the user interface.

17. A computer readable storage medium encoded with instructions that, when executed by a computer processor, cause the computer to:
register a user by associating a username and password for a new user account;
receive and storing identity information for the user, the identity information comprising the user's name, address, and date of birth;
verify the received identity information;
receive and storing payment information for the user, the payment information comprising at least one of a credit card number and a bank account number; and
build a travel profile for the user, the travel profile comprising at least one travel preference.

18. The computer readable storage medium of claim 17, wherein receiving identity information comprises receiving at least one photo of an identity document.

19. The computer readable storage medium of claim 18, wherein the instructions further cause the computer to extract identity information from the at least one photo using text recognition.

20. The computer readable storage medium of claim 19, wherein receiving identity information comprises receiving at least two photos of one or more identity documents, and wherein verifying the received identity information comprises comparing text extracted from the at least two photos for consistency.
